(19) United States
(12) Patent Application Publication
(10) Pub. No.: US 2022/0408667 A1
(43) Pub. Date: Dec. 29, 2022

(54) SYSTEM AND METHOD FOR FIELD SENSING UTILIZING IRRIGATION SYSTEM HARDWARE AND SOFTWARE

(71) Applicant: Smart Rain Systems, LLC, Centerville, UT (US)

(72) Inventor: Rudy Lars Larsen, Bountiful, UT (US)

(21) Appl. No.: 17/851,994

(22) Filed: Jun. 28, 2022

Related U.S. Application Data
(60) Provisional application No. 63/215,871, filed on Jun. 28, 2021.

(51) Int. Cl. A01G 25/16; G05B 19/4155

(52) U.S. Cl. CPC A01G 25/167; G05B 19/4155; G05B 2219/2625

(57) ABSTRACT

An irrigation system may be implemented to provide location data with respect to one or more autonomous devices. Irrigation hardware, such as moisture sensors, with known locations on a property, may be provided with field sensing to accurately determine the location of an autonomous device with respect to the known location of the irrigation hardware. Existing hardware, such as moisture sensors, may be retrofitted or provided with field sensing electronics to determine the location of autonomous devices.

### CLAIM FOR PRIORITY

A claim for priority to the Jun. 28, 2021 filing date of U.S. Provisional Patent Application No. 63/215,871, titled SYSTEM AND METHOD FOR FIELD SENSING UTILIZING IRRIGATION SYSTEM HARDWARE AND SOFTWARE (“the '871 Provisional Application”), is hereby made pursuant to 35 U.S.C. § 119(e). The entire disclosure of the '871 Provisional Application is hereby incorporated herein.

### FIELD

This disclosure relates generally to a system for field sensing, including field measurements related to measuring influence on or from apparatus, components or humans, using electromagnetic, inductive or dielectric measuring means. More specifically, the disclosure relates to a system and method for allowing sensors of an irrigation system to be integrated into a broader field sensing system.

### RELATED ART

Modern irrigation systems include one or more sensors, such as sensors to detect moisture levels, etc. Sensors may have the ability to communicate, either directly or through relay, to one or more controllers. Smart controllers and smart controller technology allows a user to quickly and effectively make changes to an irrigation system to more effectively manage water usage. Systems often have an easy way or method for a user to interact with the irrigation systems by having an application (or app) on a phone that allows them to make changes to the system. Other computers or tablets may also be used to manipulate and control the system by relaying messages to the smart controllers which carry out the tasks. Irrigation systems with smart controllers typically have a number of hardware devices across the landscape that send feedback information to the smart controller. Such devices may include water flow sensors, moisture sensors (capacitance, ultrasonic, etc.), and other devices. These devices are typically spread across a property to give accurate information about various zones or stations on the property.

Electric field sensing is a method of proximity sensing that allows computerized hardware to detect, evaluate and work with objects in their vicinity. Such computerized hardware may include autonomous or robotic lawn mowers, autonomous vehicles, etc. Because computerized hardware must be able to detect its actual location with a great degree of precision, methods to improve the detection of the location of computerized hardware are desirable.

### SUMMARY

One aspect of the present disclosure is directed to an irrigation system for use in determining location of an autonomous device, the system comprising: an irrigation controller comprising a controller processor, the irrigation controller in communication with at least two irrigation sensors and the irrigation controller in communication with the autonomous device; the at least two irrigation sensors comprising means for determining the location of the autonomous device with respect to the at least two irrigation sensors, the at least two irrigation sensors further comprising a processor configured to generate and send a signal relating to the location of the autonomous device.

According to one aspect, the means for determining the location of the autonomous device with respect to the at least two irrigation sensors comprises field sensing means. For example, the field sensing means may comprise at least one sense loop and wherein the processor of the at least two irrigation sensors determines the location of the autonomous devices based on sense loop resonant frequency measurements.

According to another aspect, the irrigation sensors may comprise at least one of moisture sensors, flow sensors, and temperature sensors.

According to another aspect, the autonomous device may be configured to change its location based on the signal relating to the location of the autonomous device received at the autonomous device.

According to another aspect, the at least two irrigation sensors further comprise a wireless communications module to send the signal relating to the location of the autonomous device to at least one of the controller and the autonomous device. In some configurations, the irrigation sensors send the signal relating to the location of the autonomous device to the controller, and wherein the controller sends the signal to the autonomous device.

According to another aspect, an irrigation system for use in determining location of an autonomous device may comprise: at least one irrigation hardware sensor in communication with the autonomous device; an auxiliary coil positioned on at least one of the irrigation hardware sensor and the autonomous device; a detector positioned in proximity to at least one of the irrigation hardware sensor and the autonomous devices, wherein the detector is configured to generate an electrical signal in response to a change in a magnetic field; and control electronics coupled to the auxiliary coil and to the detector, wherein the control electronics are configured to: activate the auxiliary coil to generate a magnetic field at a position of the detector; measure an electrical signal generated by the detector in response to the magnetic field generated by the auxiliary coil; and determine whether the autonomous device is positioned in proximity to the at least one irrigation hardware sensor based on the measured electrical signal.

In some configurations, the system may further comprise a user input device configured to accept user input from a user and to output information responsive to the user input to an irrigation controller; an irrigation controller comprising a processor in communication with the user input device and configured to generate a control signal responsive to the information; a storage medium storing instructions that, when executed, configure the processor to: send a signal to the autonomous device to change the location of the autonomous device.

According to another aspect, a method of locating an autonomous device may comprise the steps of: selecting an irrigation system comprising at least one sensor, the at least one sensor comprising field sensing means and communication means for sending a signal to an autonomous device when the field sensing means detects the presence of the autonomous device; positioning the autonomous device proximal to the at least one sensor. The irrigation system may comprise a plurality of sensors. The sensors may be positioned at different locations on the property the irrigation system serves. The sensors may comprise at least one of a moisture sensor and a flow sensor.

### BRIEF DESCRIPTION OF THE DRAWINGS

FIG. 1 is a block diagram of an irrigation system, in accordance with disclosed embodiments.

FIG. 2 is a block diagram of an exemplary landscape with an irrigation system shown on the landscape.

FIG. 3 is a block diagram of an exemplary irrigation hardware device.

FIG. 4 is a block diagram of an exemplary irrigation controller.

FIG. 5 is a block diagram of an exemplary user device.

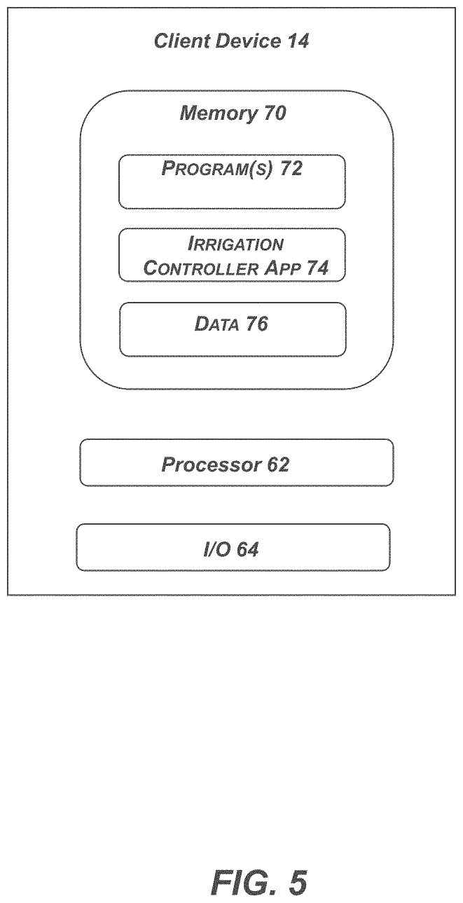

### DETAILED DESCRIPTION

Before the present invention is disclosed and described in detail, it should be understood that the present disclosure is not limited to any particular structures, process steps, or materials discussed or disclosed herein, but is extended to include equivalents thereof as would be recognized by those of ordinary skill in the relevant art. More specifically, the invention is defined by the terms set forth in the claims. The discussion of any particular aspect of the invention is not to be understood as a requirement that such aspect must be present apart from an express inclusion of the aspect in the claims. As used in this specification and the appended claims, singular forms such as “a,” “an,” and “the” may include the plural unless the context clearly dictates otherwise. Thus, for example, reference to “an electronic flow control valve” may include one or more of such valves, and reference to “the controller” or “the processor” may include reference to one or more of such controllers or such processors. Those skilled in the art should be familiar with the use of controllers in processing environments generally and, more specifically, with main memory databases. Controllers as described herein may be implemented in software, firmware, hardware or some suitable combination of at least two of the three.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments. It will also be appreciated by those skilled in the art that the words during, while, and when as used herein are not exact terms that mean an action takes place instantly upon an initiating action but that there may be some small but reasonable delay, such as a propagation delay, between the initial action and the reaction that is initiated by the initial action. Additionally, the word “connected” and “coupled” is used throughout for clarity of the description and can include either a direct connection or an indirect connection.

The following description sets forth a system for managing autonomous devices in conjunction with an irrigation system. As used herein, an “autonomous device” may be smart machines or robotics that are configured to interact directly with the landscape, such as smart lawn mowers, etc., as well as smart machines or robotics that do not interact directly with the landscape, such as automated shuttles, etc., which may still benefit from the field sensing system as described herein. The autonomous device can include additional functionalities such as an image taker, a proximity detector (such as radar, lidar, etc.), and other known hardware and/or software to collect data relating to a location of the autonomous device. In some examples, an analytical sensor to determine details such as mineral content, moisture values, fertilization requirements, etc., can also be provided on the autonomous device.

The present disclosure relates to a system and method to allow a plurality of irrigation sensors to interact with autonomous devices in field sensing applications to more accurately locate the autonomous devices and guide their movements.

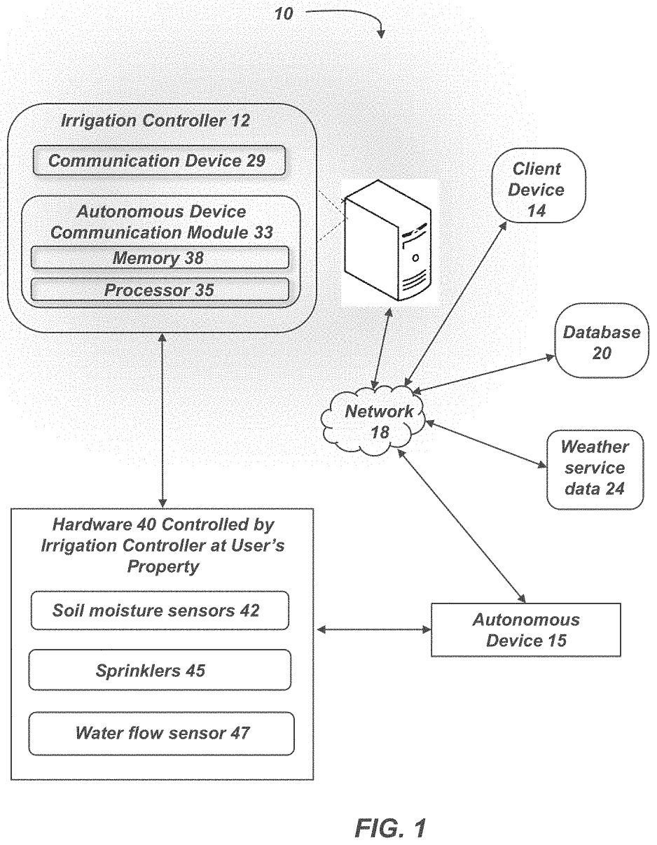

FIGS. 1-3 show various aspects of one configuration of a system 10 as described herein that includes an irrigation controller 12 implemented to communicate in a broader field sensing application. The irrigation controller 12 may be in communication with one or more client devices 14. The communication may be direct, for example, if the client device is an input device connected directly to irrigation controller 12, or the communication may be, for example, through a network 18. In some configurations, additional inputs may be received by the irrigation controller 12, and the irrigation controller may be in communication with other devices. For example, one or more databases 20, weather service data 24, etc. may be in communication with the irrigation controller 12.

The irrigation controller 12 may also be in communication with one or more autonomous devices 15. In other configurations, the autonomous device(s) 15 may be in communication with hardware 40, such as soil moisture sensors 42 and/or water flow sensors 47, and may not have direct or indirect communication with the irrigation controller 12. Where the autonomous device 15 is in communication with the irrigation controller 12, the irrigation controller 12 may be provided with an autonomous device communications module 33, which may allow a user, via one or more client device(s) 14, to control or interface with the autonomous device 15 through the controller 12.

Hardware 40 controlled by the irrigation controller 12 may include a number of various devices as desired, and all such are contemplated herein. For example, one or more sensors may be used, such as soil moisture sensors 42, water flow sensors 47, temperature sensors, rain sensors, weather stations, etc. Similarly, sprinkler heads 45 and other irrigation means may also be controller by irrigation controller 12.

The irrigation controller 12 may include a communications device 29 suitable for wired or wireless communications. For example, WiFi, LoRa, ZigBee, etc. may be used. The irrigation controller 12 may further include an autonomous device communications module 33 to allow the controller to receive from and send signals to, one or more autonomous device(s) 15. The autonomous device communications module 33 may include one or more processors 35 and memory 38.

With reference to the irrigation controller 12, the irrigation controller 12 may include one or more processors 35 and memory 38 as mentioned above, and programmable input/output peripherals, and the disclosed embodiments are not limited to any specific type of controller(s) or processor(s). The processor 35 may be in communication with memory 38, which may include one or more storage devices configured to store instructions used by processor to perform functions related to disclosed embodiments (such as instructions how to communicate with one or more autonomous device(s) 15, control signals to be sent to autonomous device(s) 15 based on pre-determined programs, etc.). For example, the memory 38 may be configured with one or more software instructions, such as programs that may perform one or more operations when executed by the processor 35. The disclosed embodiments are not limited to separate programs or computers configured to perform dedicated tasks. For example, memory 38 may include a single program that performs the functions of the processor 35, or memory 38 may comprise multiple programs. Memory 38 may also store data that is used by one or more programs (such as predetermined communication signal requirements, etc.), and/or an irrigation controller 12. In some configurations, memory 38 and associated applications may be stored within the irrigation controller 12, and in other configurations, memory 38 and associated applications may be stored at a remote location for storage and processing by the irrigation controller 12 and/or in the cloud, such as a network 18, etc.

The functions of the various elements shown in the figures, including any functional blocks labeled as “controller(s)” and/or “processor(s)”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), flash memory, and/or non-volatile storage. Other hardware, conventional and/or custom, may also be included within the irrigation controller 12 and hardware 40.

In some configurations, the autonomous device communications module 33 may include memory to store data. For example, stored data may include data relating to how the controller 12 can communicate with one or more autonomous devices 15, and may include one or more programs relating to specific signals to be sent to autonomous device(s) 15 based on specific signals received from hardware 40, autonomous devices 15, and/or other inputs such as weather service data 24. For example, stored data may include instructions to execute a program when an input signal is received, as described in more detail below.

The irrigation controller 12 may optimize a control signal to be sent to the hardware 40 and/or autonomous device(s) 15 through one or more aspects of hardware, such as, but not limited to, one or more transformers, bridge circuits, solid-state relays (such as two or more pairs of diagonal pair solid-state relays), MOSFETs, full-wave rectifiers, etc. The irrigation controller 12 may also optimize a control signal to be sent to the hardware 40 and/or autonomous device(s) 15 through one or more aspects of software for communication.

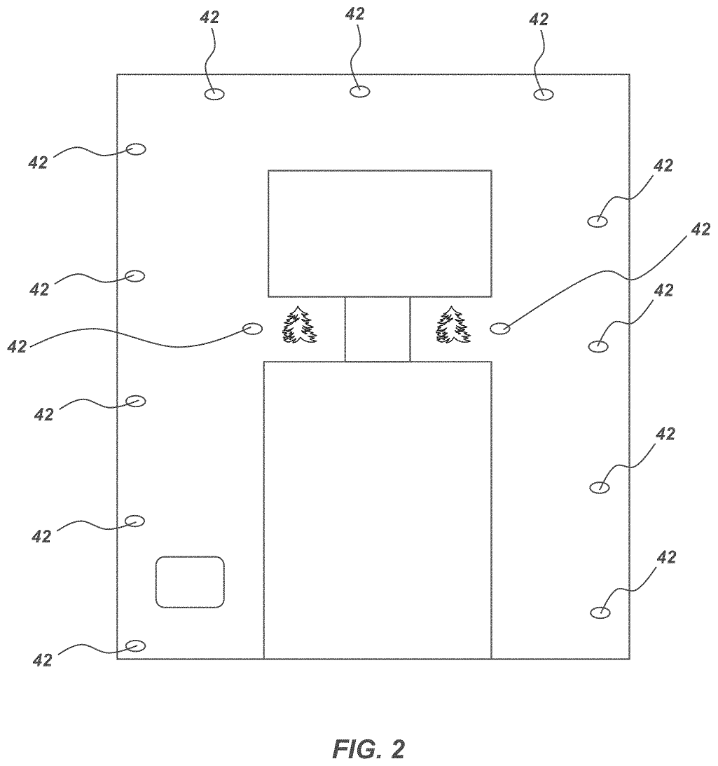

In a typical irrigation system, hardware 40 is placed at various locations on the landscape that the irrigation system covers. FIG. 2 shows an exemplary landscape with a plurality of soil moisture sensors 42. Because the soil moisture sensors 42 are spread over the landscape at various locations, they can serve to interact with one or more autonomous devices 15 to improve the location information of the autonomous device 15, and more accurately predict the location of the autonomous device 15 by providing a data point with respect to a known location. For example, the location of each hardware device 40 on the landscape may be accurately predetermined (such as by use of GPS on installation of the hardware, or by a user programming the location by “dragging and dropping” the hardware onto an interactive map, etc.) and/or programmed into the memory of the hardware 40 and/or the irrigation controller 12.

In some configurations, the autonomous device 15 may use pre-existing hardware 40 located on a property to more accurately determine its location. In other configurations, hardware 40 may be installed to create a “fence” or boundary for the autonomous device 15, such as at or proximal to a perimeter of a lawn. The autonomous device 15 may then have an additional method to prevent it from going off-course or to a location that may cause damage to the autonomous device 15 and/or damage to property.

The hardware 40 used to interact with the autonomous device may be any suitable hardware 40 that is either preexisting within an irrigation system, or may be specially installed to interact with both the irrigation system and/or the autonomous device 15. In some configurations, the hardware 40 may be retrofitted to interact with the autonomous device. In other configurations, the hardware 40 may be used as it exists.

Similarly, preexisting autonomous devices 15 may be used in the sensing system described herein, or in other configurations, autonomous devices 15 may be retrofitted. Autonomous devices typically have methods of sensing already built-in (such as GPS, WiFi, etc.), so the system as described herein can serve as redundancy for ensuring that the built-in location prediction of the autonomous device is accurate. As the autonomous device moves on the property, it can receive data regarding its location from both its pre-existing or built-in location sensors, as well as data from the hardware 40 and/or controller 12. Increased redundancy improves the location sensing and accuracy of the autonomous device 15.

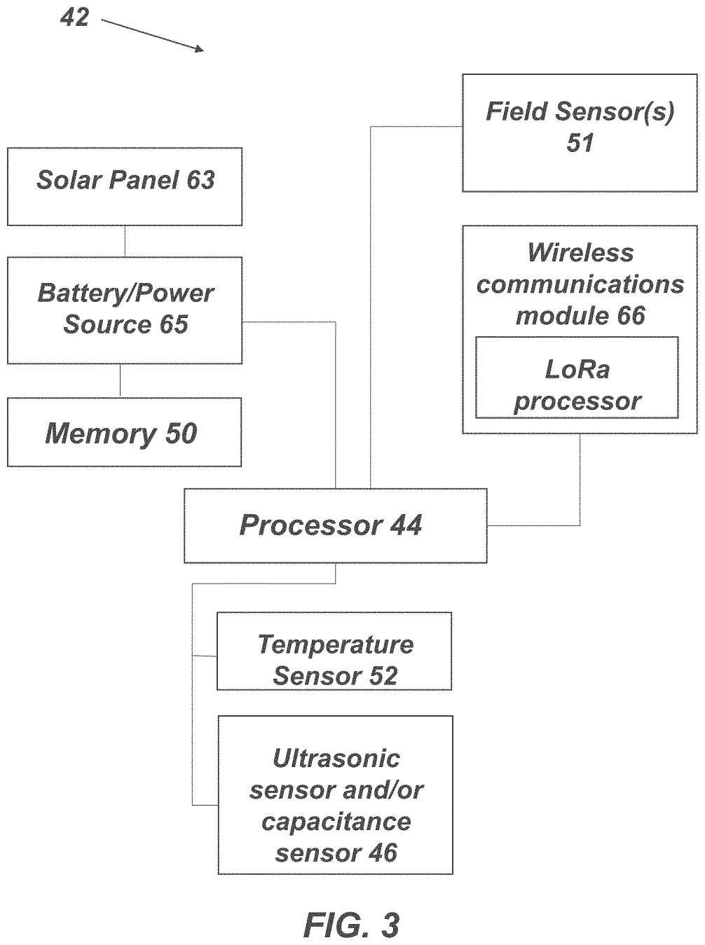

An example of irrigation hardware that is contemplated in the present system is a moisture sensor 42. Other types of hardware, such as other types of moisture sensors, flow sensors, etc., may also be used. The moisture sensor 42 may include an ultrasonic sensor and/or capacitance sensor 46 to sense water levels in the soil (FIG. 3). The moisture sensor 42 may also include a temperature sensor 52, a memory 50, a battery 65, an optional solar panel 63, and one or more field sensors 51 in communication with a processor 44. Battery or power source 65 can include a battery, local inline power, or a field energy generator (such as solar or a flow sensing power wheel). For example, an inline flow generator can be used as a power source or any other renewable field energy generator.

The processor 44 of the moisture sensor 42 may also be in communication with one or more wireless communications modules 66. The wireless communications module 66 may be any suitable wireless communications module known in the art, such as satellite communication, low-range wireless communication, Bluetooth, WiFi, infrared communication, Bluetooth Low Energy, WiMax, Wi-Fi 6, Wi-Fi 7, any other wireless communications technologies that will be developed, etc. In some configurations, LoRa technology may be used. LoRa (short for long range) is a spread spectrum modulation technique derived from chirp spread spectrum (CSS) technology. LoRa devices and wireless radio frequency technology uses a long range, low power wireless platform that has become widely used for Internet of Things (IoT) networks worldwide. Any suitable wireless communication may be used to allow for extended connection across a wide geographical area. For example, the wireless communications module 66 may comprise an antenna, such as an SMA antenna connector or any other suitable antenna, and a wireless communications processor. The wireless communications module 66 may allow for the processor 44 to communicate sensor data to a central irrigation controller 12, one or more autonomous devices 15, and/or may allow the moisture sensor 42 to receive data from the central irrigation controller 12 and/or one or more autonomous devices 15.

Moisture sensors 42 may be either provided with or retrofitted with means for interacting with and detecting the location of an autonomous device 15. Such means may include any suitable means known in the art, and in some configurations, field sensors 51 may be provided in communication with the processor 44 of the moisture sensor 42.

In accordance with exemplary and non-limiting embodiments, an irrigation-hardware based field sensing system may measure perturbations in the electromagnetic field around one or more sense loops using magnetic field sensors and/or gradiometers. The sensors and/or gradiometers may be positioned either on the irrigation hardware 40 and/or on the autonomous device(s) 15. For example, in some configurations, a field sensor may be placed on the hardware 40, with the hardware 40 detecting the proximity of the autonomous device 15. In other configurations, a field sensor may be placed on the autonomous device 15, with the autonomous device detecting the proximity of the hardware 40.

The sensors and/or gradiometers used for field sensing detection may include lengths of wire and/or printed conductor traces and/or any type of conducting path and they may include a single or multiple conducting paths. The conducting path or paths may be constructed to substantially cover the area where autonomous devices 15 may need to be detected (by way of example and not of limitation, proximal to a top portion of the irrigation hardware 40). In an exemplary configuration, an electric field sensor may be a single conducting path that travels back and form across the surface of at least one of the autonomous device 15 and the irrigation hardware 40 and in another embodiment there may be multiple substantially straight conducting paths that traverse at least one of the autonomous device 15 surface and the irrigation hardware 40 surface and are sensed individually or after a parallel electrical connection and/or in a multiplexed manner. The electric field sensors and/or gradiometers may be connected to high-input-impedance readout circuitry. The readout circuitry may measure the voltage and/or the current and/or the relative phase of the voltages and/or currents in the sensors. In some configurations, a system may include multiple layers of sensors to increase the detection probability of the autonomous device 15. In embodiments, hardware 40 and/or autonomous device(s) 15 may be designed with one or more field sensors without significantly affecting other characteristics of a wired or wireless irrigation system such as the ability of the irrigation hardware to communicate with other irrigation hardware and/or irrigation controllers.

For example, sensors to detect the presence of an autonomous device may include one or more of antenna, capacitance or other electric field sensor or other electromagnetic wave sensor, magnetic field sensor, etc. For example, a magnetic field sensor that is configured to sense changes or interruptions (e.g., via the Hall effect) in a magnetic field may be used. When a body or device is proximal to the magnetic sensor, the sensor can generate a signal that indicates a change to an ambient magnetic field. For example, the magnetic sensor can include a Hall effect sensor that varies a voltage output signal in response to variations in a detected magnetic field. Voltage changes at the output signal can be due to production of a voltage difference across an electric signal conductor, such as transverse to an electric current in the conductor and a magnetic field perpendicular to the current.

In accordance with exemplary and non-limiting embodiments, an irrigation system that may include at least one autonomous device detection system that includes at least one energy source configured to generate an oscillating magnetic field. The autonomous device may be detected by a field sensor positioned in the oscillating electromagnetic field. The voltages and/or currents of the field sensors may be measured using readout circuitry and a feedback loop based on the readings from the sensors may be used to control the parameters of the wireless energy source.

In some configurations, inductive sensing may be used, particularly if the autonomous device to be detected comprises metal or if the hardware 40 the autonomous device is detecting comprises metal. For example, one or more irrigation hardware 40 devices, such as moisture sensors, may be provided with a sense loop. Changes of loop induced voltage may occur as objects are placed within the loop. Adjacent loops may be provided, and simultaneous changes in adjacent loops can be exploited in post processing to improve overall detection sensitivity in accordance with various embodiments. For example, known arrays of overlapping loops may improve innate sensitivity of an inductive sensor system. A square or rectangular-shaped loop may be used, or loops may be circular-, hexagonal-, triangular-shaped in accordance with various embodiments. In one loop array, densely packed hexagonal loops may provide improved sensitivity with a non-overlapping structure requiring a lower number of copper layers when implemented in a printed circuit board.

Moreover, the loop's size, shape or raster size may be adapted to local sensitivity requirements. For the loop impedance measuring method, other loop topologies such as double loops, triple loops (clover leave), or even quadruple loops, producing a magnetic flux arch from one pole area to another pole area when driven by a sense current. In accordance with some embodiments, using an orthogonal loop system (loops substantially in perpendicular planes e.g., a planar coil and a solenoid) may also enhance sensitivity of the loop induced voltage method. Since metal objects may generally change the direction of the magnetic field in their surroundings, sensing flux components by an orthogonal loop arrangement may provide additional information to improve the detector's performance.

As mentioned above, stored data, such as data stored by memory 50 of a soil moisture sensor 42 or memory 38 of an irrigation controller 12, may include instructions to execute particular programs when an input signal is received. For example, if a controller or sensor receives a signal that the autonomous device is off course, it could execute a program to shut down the autonomous device or re-set the autonomous device back on course. This may prevent property damage from autonomous devices moving outside their allowed boundaries, such as if an autonomous mower started to operate outside a law and into a flower bed.

In another exemplary application of the present system, a controller 12 may be in communication with input such as weather service data 24. When the weather service data 24 indicates that precipitation is expected, the controller 12 and/or hardware 40 may be programmed to send a signal to the autonomous device(s) 15 to interrupt their actions and return to a storage position. This may be useful in the setting of one or more autonomous lawn mowers, as watering wet grass can damage a lawn mower. The water causes the grass to be heavier which can damage the lawn mower's drive or engine. Similarly, if lightning that may damage the autonomous device is predicted by the weather service data 24, the autonomous device 15 may be sent a signal to return to the stored position or another safe location.

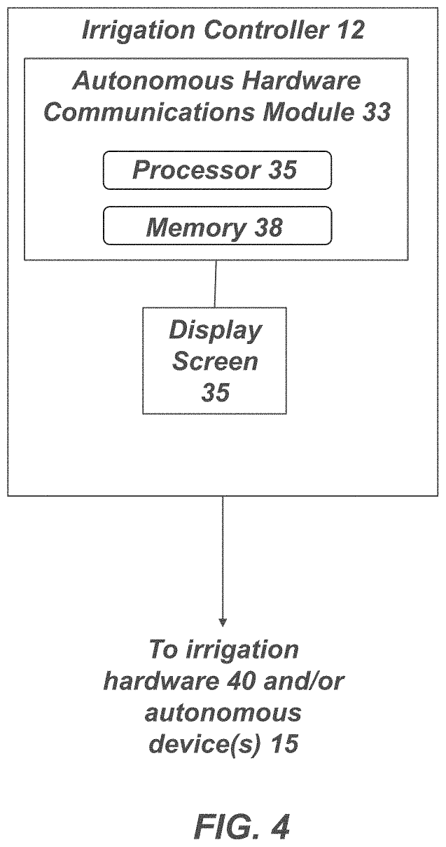

Also mentioned above is the possibility for a client device to interact with the system through the controller 12. FIG. 4 is a block diagram of one embodiments of a client device 14, in accordance with disclosed embodiments. In one embodiment, client devices 14 may include one or more processors 62, one or more input/output (I/O) devices 64, and one or more memories 70. In some embodiments, client devices 105 may take the form of mobile computing devices such as smartphones or tablets, general purpose computers, or any combination of these components. Alternatively, client devices 14 (or systems including client devices 14) may be configured as a particular apparatus, embedded system, dedicated circuit, and the like based on the storage, execution, and/or implementation of the software instructions that perform one or more operations consistent with the disclosed embodiments. According to some embodiments, client devices 14 may comprise web browsers or similar computing devices that access a web site, for example with web-based software, consistent with disclosed embodiments. In one implementation the system 10 is connected to one or more client devices 14-1, 14-2, 14-3, etc., individually and commonly referred to as client device(s) 14 hereinafter, through a communication network 18. A plurality of client devices may be desirable for example, so an irrigation system owner and/or an irrigation system services provider may have access to the system for inputs and outputs. The client devices 14 may provide specific instructions relating to the autonomous devices 15 used in conjunction with the system, such as instructions to change positions, run a pre-determined program, etc.

In some configurations, the client devices 14 may also be used to inform and/or alert the client about the location of the autonomous device(s) 15 and/or steps taken by the system and/or the autonomous device(s) 15. The client devices 14 may serve both to provide specific instructions regarding steps to be taken by autonomous devices, and to input into the system data relating to the other aspects of the irrigation system, such as the hardware 40, and/or specific types of autonomous device(s) 15 used within the system 10. Such client devices 14 include, but are not limited to, desktop computers, hand-held devices, laptops or other portable computers, tablet computers, mobile phones, PDAs, Smartphones, Smart energy meters, Smart home monitoring systems, smart electric appliances, and the like. Further, the client devices 14 may include devices capable of exchanging data to provide connectivity to different communicating devices and computing systems. Such devices may include, but are not limited to, data cards, mobile adapters, wireless (WiFi™) adapters, routers, a wireless modem, a wireless communication device, a cordless phone, a wireless local loop (WLL) station, and the like. As client devices 14 may be stationary or mobile and may also be understood to be a mobile station, a terminal, an access terminal, a subscriber unit, a station, etc.

Processor 62 may include one or more known processing devices, such as mobile device microprocessors manufactured by Intel™, NVIDIA™, or various processors from other manufacturers. The disclosed embodiments are not limited to any specific type of processor configured in client devices 14. Memory 70 may include one or more storage devices configured to store instructions used by processor 62 to perform functions related to disclosed embodiments. For example, memory 70 may be configured with one or more software instructions, such as programs 72 that may perform one or more operations when executed by processor 62. The disclosed embodiments are not limited to separate programs or computers configured to perform dedicated tasks. For example, memory 410 may include a single program 72 that performs the functions of the client devices 14, or program 412 may comprise multiple programs. Memory 70 may also store data 76 that is used by one or more programs 72, and/or an irrigation controller application 74. The irrigation controller application 74, for example, may be used to allow a user to input information with respect to specific autonomous device(s) 15 used in the system, including a type/specification of autonomous device(s), and/or specific instructions to send to the autonomous device(s) regarding actions to be taken.

I/O devices 64 may include one or more devices configured to allow data to be received and/or transmitted by client devices 14 and to allow client devices 14 to communicate with other machines and devices, such as other components of irrigation system 10. For example, I/O devices 64 may include a screen for providing information to the user. I/O devices 64 may also include components for NFC communication. I/O devices 64 may also include one or more digital and/or analog devices that allow a user to interact with client devices 14 such as a touch-sensitive area, buttons, or microphones. I/O devices 64 may also include one or more accelerometers to detect the orientation and inertia of client devices 14. This may be communicated to the irrigation controller 12, for example, to determine the location of the client with respect to the irrigation system 10 and what hardware 40 they are proximal to and may wish to adjust and/or control. I/O devices 64 may also include other components known in the art for interacting with irrigation system 10. The components of client devices 104 may be implemented in hardware, software, or a combination of both hardware and software, as will be apparent to those skilled in the art.

According to another aspect, systems and methods for calibration could include GPS or proximity to the controller. For example, an autonomous device can receive GPS coordinates in combination with proximity measurements for an irrigation controller and/or irrigation sensors. These GPS coordinates, together with proximity measurements, can be overlayed on a map. Additionally, GPS can be used to provide calibration. In some examples, a map pinned feature can allow a user to set a virtual pinned point on an overlay map. The map pinning feature can allow a user to set a virtual point for their location on the map, a point for a danger spot, or a virtual anchor point. Several points can be pinned on the map and this feature can be used to map specific terrain that is challenging for autonomous devices to maneuver.

Although the foregoing disclosure provides many specifics, these should not be construed as limiting the scope any of the ensuing claims. For example, any type of autonomous device may be used, and the disclosure is not limited to autonomous lawn care equipment. Other autonomous devices such as cars or transportation devices, etc. are also contemplated herein. For example, autonomous drones used to deliver packages to the property may interact with one or more hardware 40 devices to accurately determine the location of the drone on the property. Similarly, other robotics such as delivery robots may interact with the irrigation system for accurate location determination. Other embodiments may be devised which do not depart from the scopes of the claims. Features from different embodiments may be employed separately or in combination. Accordingly, all additions, deletions and modifications to the disclosed subject matter that fall within the scopes of the claims are to be embraced thereby. The scope of each claim is indicated and limited only by its plain language and the full scope of available legal equivalents to its elements.

I claim:

1. An irrigation system for use in determining location of an autonomous device, the system comprising:
an irrigation controller comprising a controller processor, the irrigation controller in communication with at least two irrigation sensors and the irrigation controller in communication with the autonomous device;
the at least two irrigation sensors comprising means for determining the location of the autonomous device with respect to the at least two irrigation sensors, the at least two irrigation sensors further comprising a processor configured to generate and send a signal to the irrigation controller relating to the location of the autonomous device.

2. The system of claim 1, wherein the means for determining the location of the autonomous device with respect to the at least two irrigation sensors comprises field sensing means.

3. The system of claim 2, wherein the field sensing means comprises at least one sense loop and wherein the processor of the at least two irrigation sensors determines the location of the autonomous devices based on sense loop resonant frequency measurements.

4. The system of claim 1, wherein the at least two irrigation sensors comprise at least one of moisture sensors, flow sensors, and temperature sensors.

5. The system of claim 1, wherein the autonomous device is configured to change its location based on the signal relating to the location of the autonomous device received at the autonomous device.

6. The system of claim 1, wherein the at least two irrigation sensors further comprise a wireless communications module to send the signal relating to the location of the autonomous device to at least one of the controller and the autonomous device.

7. The system of claim 6, wherein the at least two irrigation sensors send the signal relating to the location of the autonomous device to the controller, and wherein the controller sends the signal to the autonomous device.

8. An irrigation system for use in determining location of an autonomous device, the system comprising:
at least one irrigation hardware sensor in communication with the autonomous device;
an auxiliary coil positioned on at least one of the irrigation hardware sensor and the autonomous device;
a detector positioned in proximity to at least one of the irrigation hardware sensor and the autonomous devices, wherein the detector is configured to generate an electrical signal in response to a change in a magnetic field; and
control electronics coupled to the auxiliary coil and to the detector, wherein the control electronics are configured to:
activate the auxiliary coil to generate a magnetic field at a position of the detector;
measure an electrical signal generated by the detector in response to the magnetic field generated by the auxiliary coil; and
determine whether the autonomous device is positioned in proximity to the at least one irrigation hardware sensor based on the measured electrical signal.

9. The system of claim 8, further comprising a user input device configured to accept user input from a user and to output information responsive to the user input to an irrigation controller;
an irrigation controller comprising a processor in communication with the user input device and configured to generate a control signal responsive to the information;
a storage medium storing instructions that, when executed, configure the processor to:
send a signal to the autonomous device to change the location of the autonomous device.

10. A method of locating an autonomous device, the method comprising the steps of:
selecting an irrigation system comprising at least one sensor, the at least one sensor comprising field sensing means and communication means for sending a signal to an autonomous device when the field sensing means detects the presence of the autonomous device;
positioning the autonomous device proximal to the at least one sensor.

11. The method of claim 10, wherein the irrigation system comprises a plurality of sensors.

12. The method of claim 11, wherein the plurality of sensors comprise at least one of a moisture sensor and a flow sensor.
